(19) United States
(12) Patent Application Publication
(10) Pub. No.: US 2014/0356632 A1
(43) Pub. Date: Dec. 4, 2014

(54) WATER-RESISTANT SURFACE TREATMENT FOR WOOD PRODUCTS

(71) Applicant: WEYERHAEUSER NR COMPANY, FEDERAL WAY, WA (US)

(72) Inventors: Erik M. Parker, Bonney Lake, WA (US); Jack G. Winterowd, Puyallup, WA (US)

(21) Appl. No.: 13/906,181

(22) Filed: May 30, 2013

(51) Int. Cl. B05D 7/06

(52) U.S. Cl. CPC B05D 7/06
USPC 428/425.1; 427/342; 427/341; 427/297

(57) ABSTRACT

The present disclosure provides compositions formulated to improve water resistance when topically applied as a treatment to a surface (e.g., the surface of a wood product). Wood products treated with the compositions, as well as methods for applying the compositions to a surface, are also provided.

### BACKGROUND

Often wooden construction materials used for residential construction such as wooden framing members and sheathing are stored for a period of time outdoors in a lumber yard and at construction sites where they are exposed to the elements, including rain, snow, or other forms of precipitation. Wood products that come into contact with water during their exposure to the elements tend to increase in volume as they absorb moisture. This becomes a problem during the construction process when construction materials are no longer uniform in size. In order to create defect free uniform walls, roofs and floors it is necessary to have building materials with uniform shape and size. Construction products that have changed dimensions due to water absorption require sanding, planning, or reshaping before adjacent materials can be properly installed. In some cases drying will reestablish geometric uniformity. The length of drying time required will generally be proportional to the amount of absorbed moisture, which will be proportional to the rate which the wooden object absorbs moisture during the exposure event. Thus, wooden materials that absorb moisture at a slower rate allow for less rework and less drying time during the building process.

Wood is also used for decking and fencing applications, which also involve exposure to precipitation. The exposure times for these applications are even greater than those associated with structural framing and sheathing in residential construction. When wooden decks are exposed to precipitation they will absorb moisture and expand in both width and thickness and can also cup. The repeated absorption of moisture, expansion of wood, and subsequent drying and contraction can cause checking and cracking which results in reduced service life. Exposure of wooden fencing to precipitation can cause similar problems. Again, the adverse effects of precipitation exposure tend to be minimized when the wooden material absorbs water more slowly.

Various techniques for slowing water absorption in wooden building materials are known. These include incorporation of wax into wood-based composites during manufacture, application of sealants or coatings, and chemical modification of the wood. Examples of sealants include water-based wax emulsions and drying oils, such as linseed or tung oil. Examples of coatings include polyurethanes and latex paints. Polyurethanes are made by reacting isocyanates with polyols such as described in U.S. Pat. No. 6,136,408, which is hereby incorporated by reference in its entirety. It is also known to chemically modify wood such as by acetylation or furfuralation.

Despite existing methods for reducing water absorption in wood products, improved methods and compositions are desirable.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method of forming a water-resistant wood product is provided. In one embodiment, the method includes:

applying a liquid formulation to a surface of a wood product, the liquid formulation comprising 5%-100%, by mass, of aromatic multifunctional isocyanates, wherein 55%-100%, by mass, of the aromatic multifunctional isocyanates have a molecular weight of 300 daltons or less; and

reacting the aromatic multifunctional isocyanates with a reactant in order to provide a water-resistant wood product; wherein the reactant is selected from the group consisting of water, a wood-based alcohol functional group, and combinations thereof. In another aspect, a water-resistant wood product formed by the method is provided.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a photograph of a block of parallel strand lumber;

FIG. 2 is a photograph of an untreated parallel strand lumber sample, and one treated with a representative composition, at the end of a three day one-sided wetting test;

FIG. 3 is a photograph of a side-by-side comparison between parallel strand lumber samples exposed to a three day one-sided wetting test;

FIG. 4 is a photograph of parallel strand lumber samples treated with a representative formulation after exposure to a three day one-sided wetting test; and

FIG. 5 is a photograph of untreated parallel strand lumber samples after exposure to a three day one-sided wetting test.

### DETAILED DESCRIPTION

The present disclosure provides compositions formulated to improve water resistance when topically applied as a treatment to a surface (e.g., the surface of a wood product). Wood products treated with the compositions, as well as methods for applying the compositions to a surface, are also provided.

Well-known structures, systems, and methods often associated with the disclosed embodiments have not been shown or described in detail to avoid unnecessarily obscuring the description of various embodiments of the disclosure. In addition, those of ordinary skill in the relevant art will understand that additional embodiments of the disclosure may be practiced without several of the details described below. Certain terminology used in the disclosure is defined as follows.

“Wood product” is used to refer to a product manufactured from logs, such as lumber (e.g., boards, dimension lumber, solid sawn lumber, joists, headers, beams, timbers, moldings, laminated, finger jointed, or semi-finished lumber), composite wood products, or components of any of the aforementioned examples.

“Composite wood product” is used to refer to a range of derivative wood products which are manufactured by binding together the strands, particles, fibers, or veneers of wood, together with adhesives, to form composite materials. Examples of composite wood products include but are not limited to glulam, plywood, parallel strand lumber (PSL), oriented strand board (OSB), oriented strand lumber (OSL), laminated veneer lumber (LVL), laminated strand lumber (LSL), particleboard, medium density fiberboard (MDF), cross-laminated timber, and hardboard.

When a wood product is treated with the provided methods, a water-resistant wood product is provided. As used herein, the term “water-resistant wood product” refers to a treated state of a wood product wherein the treated wood product, when exposed to water, absorbs less water than a similar but untreated wood product subjected to the same water exposure. Examples of this are described below with regard to the three-day one-sided wetting test and the 14-day submersion test. The EXAMPLES illustrate the improvement in water resistance of wood products formed according to the disclosed methods.

In one aspect, a method of forming a water-resistant wood product is provided. In one embodiment, the method includes:

applying a liquid formulation to a surface of a wood product, the liquid formulation comprising 5%-100%, by mass, of aromatic multifunctional isocyanates, wherein 55%-100%, by mass, of the aromatic multifunctional isocyanates have a molecular weight of 300 daltons or less; and

reacting the aromatic multifunctional isocyanates with a reactant in order to provide a water-resistant wood product; wherein the reactant is selected from the group consisting of water, a wood-based alcohol functional group, and combinations thereof.

In another aspect, a water-resistant wood product formed by the methods is provided.

In certain embodiments, the disclosure includes a method of creating wood products with reduced water absorption rate. Specifically, manufactured wood based composites or semi-finished lumber are impregnated with a penetrating liquid formulation comprised of 5%-100% (by mass) of aromatic multifunctional isocyanates, wherein 55%-100% (by mass) of the isocyanates have a molecular weight of 300 daltons or less; and subsequent deliberate exposure to moisture to facilitate rapid reaction of the isocyanate.

The Liquid Formulation

The liquid formulation is comprised of 5%-100%, by mass, of aromatic multifunctional isocyanates. In one embodiment, the liquid formulation comprises from 25% to 100%, by mass, of aromatic multifunctional isocyanates. In one embodiment, the liquid formulation comprises from 50% to 100%, by mass, of aromatic multifunctional isocyanates. In one embodiment, the liquid formulation comprises from 60% to 100%, by mass, of aromatic multifunctional isocyanates. In one embodiment, the liquid formulation comprises from 70% to 100%, by mass, of aromatic multifunctional isocyanates. In one embodiment, the liquid formulation comprises from 80% to 100%, by mass, of aromatic multifunctional isocyanates. In one embodiment, the liquid formulation comprises from 90% to 100%, by mass, of aromatic multifunctional isocyanates.

The aromatic multifunctional isocyanates are 55%-100%, by mass, aromatic multifunctional isocyanates having a molecular weight of 300 daltons or less. The relatively small size of these aromatic multifunctional isocyanates allows for the molecules to quickly and completely penetrate the surface of the wood product, which serves to speed absorption into the wood product (e.g., penetration) and improve the quality of the water resistance of the treated wood product.

For comparison, polymeric methylene diphenyl diisocyanate (pMDI) has at most 50%, by mass, aromatic multifunctional isocyanates having a molecular weight of 300 daltons or less. However, pMDI tends to form a film when topically applied to a wood product and does not absorb or penetrate into the wood product to as great of an extent as the present methods. Conversely, the compositions of the provided methods have a lower molecular weight aromatic multifunctional isocyanate composition that allows for absorption and penetration into the wood surface in order to provide a chemically treated wood product that is water resistant, as opposed to a water-resistant coating on the surface of the wood product.

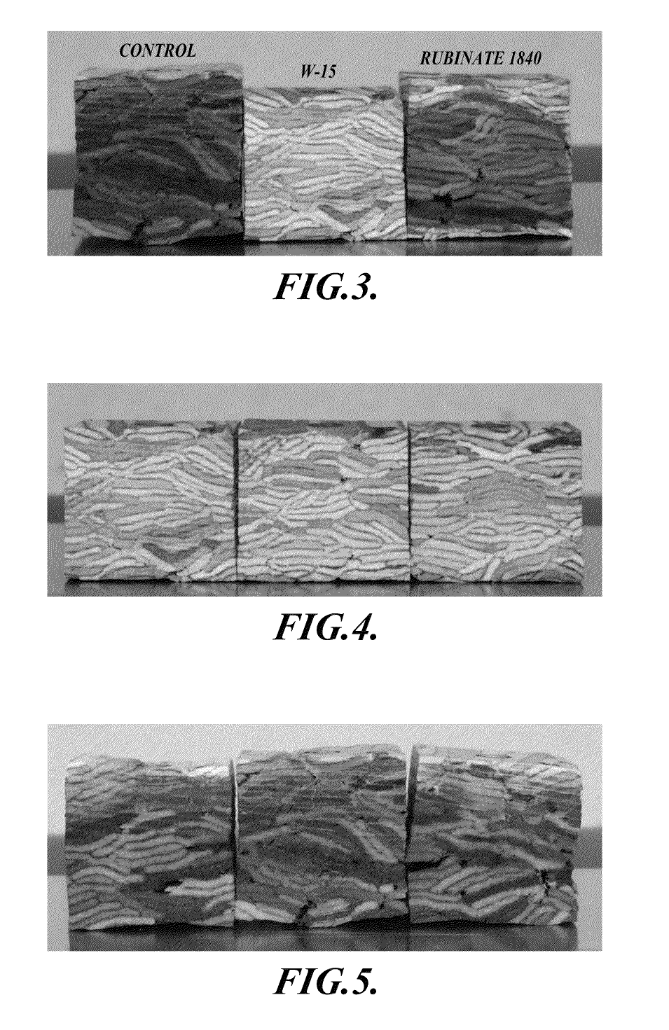

Furthermore, the provided methods introduce the aromatic multifunctional isocyanates into the inner regions of the wood product. That is, the liquid composition diffuses deep into the wood product, and in some cases entirely through the wood product. As illustrated in the EXAMPLES (e.g., Example 3 and related FIG. 3), wood products treated according to the provided methods are water resistant throughout the wood product, not just near the surface. Referring to FIG. 3, the Rubinate sample is pMDI (i.e., high molecular weight aromatic multifunctional isocyanates), while the W-15 sample has low molecular weight aromatic multifunctional isocyanates according to the provided embodiments. The difference in molecular weight profile produces unexpected and dramatic results in terms of the water resistance. The W-15 sample remains dry and whole, while the Rubinate sample absorbs water, warps, and expands in thickness.

The unexpected and dramatic improvement provided by reducing the molecular weight of the composition applied to the wood product is illustrated, in one embodiment, in the Example 3 comparison between pMDI treated wood and wood treated by the provided methods.

In one embodiment, 70% to 100%, by mass, of the aromatic multifunctional isocyanates have a molecular weight of 300 daltons or less. In one embodiment, 80% to 100%, by mass, of the aromatic multifunctional isocyanates have a molecular weight of 300 daltons or less. In one embodiment, 90% to 100%, by mass, of the aromatic multifunctional isocyanates have a molecular weight of 300 daltons or less.

Examples of aromatic multifunctional isocyanates with a molecular weight of 300 daltons or less include the diphenylmethane diisocyanates (MDI): diphenylmethane 4,4′ diisocyanate; diphenylmethane 2,4′ diisocyanate; and diphenylmethane 2,2′ diisocyanate. Other exemplary aromatic multifunctional isocyanates include toluene diisocyanates (TDI), including 2,4-TDI and 2,6-TDI.

In addition to the isocyanate the formulation can include other component additives that may be incorporated to achieve beneficial effects. These include, but are not limited to penetration aids, colorants, catalysts, preservatives, biocides, diluents, and other additives that might promote the production, storage, processing, application, function, cost and/or appearance of the wood products.

An example of a penetration aid is an organofunctional silane. Preferred silanes have short chain organofunctional groups because they can react with moisture without the aid of a catalyst and may penetrate the substrate to a greater degree and more quickly. Silanes that have methoxy or ethoxy groups are preferred. Examples of short chain silanes are methyltrimethoxysilane, methyltriethoxysilane, and vilyltrimethoxy silane. Trade names for vilyltrimethoxy silane include Silquest A-171 manufactured by Momentive Specialty Chemicals, and Dynasylan VTMO manufactured by Evonik industries. An example of methyltriethoxysilane is Dynasylan MTES manufactured by Evonik industries. An example of methyltrimethoxysilane is Dynasylan MTMS manufactured by Evonik industries. Examples of diluents include propylene carbonate, triacetin, petroleum derived aromatic oils such as those manufactured by the Crowley Chemical Company. Examples of biocides include pyrethroids such as bifenthrin, imadcloprid, deltamethrin and derivatives of nicotine.

Catalysts include typical polyurethane catalysts such as organo tins or tertiary amines. An example of an organo tin catalyst is dibutyltin dilaurate manufactured under the trade name DABCO T-12 by Air Products. Examples of tertiary amine catalysts are Dabco MP601, Dabco 1027, DABCO BL 19, and DABCO B-16 manufactured by Air Products and Niax C-41 manufactured by Momentive. Typical catalysts for silanes include products based on organometallic compounds, acids and amine compounds.

In all cases, the non-aromatic-multifunctional-isocyanate component additives should not constitute more than 95% by mass of the penetrating liquid formulation.

In order to promote penetration of the penetrating liquid formulation into the wooden substrate, the viscosity should be below about 100 centipoise (e.g., as measured with a Brookfield Viscometer (#2 spindle, 20 rpm, 20° C.).

The liquid formulation can be applied to one, several, or all surfaces of a wood product. In one embodiment, the application level is about 1 g/ft² to about 100 g/ft². In one embodiment, the application level is from about 5 g/ft² to 60 g/ft². In one embodiment, the application level is from about 5 g/ft² to 30 g/ft². In one embodiment, the application level is from about 5 g/ft² to 20 g/ft². The application level may depend on the nature of the wood product to which the coating is applied, intended use, and performance requirements.

The liquid formulation can be applied in any manner that would be suitable to a person of ordinary skill in the art, such as spray systems, extruders, curtain coaters, roll coaters, vacuum or pressure treating and other application equipment. In some situations, the penetrating liquid formulation may be applied manually with a hand-held applicator (e.g., a brush or roller).

Reacting the Liquid Formulation

After the liquid formulation is applied to one or more surfaces of the wood product, the aromatic multifunctional isocyanates are reacted to provide a water-resistant wood product. The reaction mechanism typically includes a nucleophile, such as water, amines, and/or alcohols.

In one embodiment, the reaction is with water to form polyureas. In another embodiment, the reaction is with wood (e.g., a wood-based alcohol functional group on cellulose, hemicellulose, and/or lignin) to form a polyurethane. It will be appreciated that other reaction mechanisms can be used to react the aromatic multifunctional isocyanates, including reactions with amine-containing compounds (e.g., ammonia sprayed onto the wood product).

When the reaction is facilitated by water, the reaction between the aromatic multifunctional isocyanates and water is accomplished by exposing the applied liquid formulation to water. Given the presence of atmospheric water, simply leaving the coated wood product exposed to ambient conditions will effect reaction of the aromatic multifunctional isocyanates. However, such an approach is time consuming and may produce uneven results based on changing humidity conditions over the course of several day, weeks, or months, as the reaction proceeds.

Accordingly, in one embodiment the coated wood product is deliberately exposed to water in greater than atmospheric amounts. Such deliberate exposure methods include exposure to humidity rooms, steam, and liquid water spray. In all cases the purpose of the deliberate exposure to water is to facilitate rapid cure of the penetrating liquid formulation. Deliberate exposure will decrease reaction time and thereby improve production efficiency while reducing industrial hygiene issues related to isocyanate vapors.

Absent water, such as in extremely dry wood, the aromatic multifunctional isocyanates may only react with the wood itself. Typically, when water is present, the reactions will be a mixture of water-based and wood-based reaction to form a mixture of polyureas and polyurethanes.

While the liquid formulation is applied to the surface of the wood product, a film of the reacted aromatic multifunctional isocyanates is not formed. Instead, the aromatic multifunctional isocyanates penetrate the surface of the wood and react (e.g., with water within the wood, or the wood itself). Therefore, while some aromatic multifunctional isocyanates may reside on the exterior of the wood product, a traditional film is not formed. In certain embodiments, a film of the reacted liquid formulation is not formed on the surface of the wood product. This is because all of the liquid formulation penetrates the surface of the wood product and absorbs within before reacting.

Testing Water Resistance

The water-resistant wood products formed by the methods will absorb less water after prolonged exposure than an untreated wood product that is not treated with the liquid formulation.

For wood products there are several “prolonged exposure” (e.g., three- or 14-day) tests that can be used to determine the water absorption rate. One test is a one-sided wetting test. In a one-sided wetting test the wood product is set on top of a wet material that is kept wet for the duration of the test. The mass and dimensions of the wood product are measured before and at multiple times during the exposure. The mass increase of the wood product indicates the amount of water that has transferred into the product and any change in the dimensions of the product indicates the effect that the absorbed moisture has had on the product.

Another test is a submersion test, which lasts 14 days in certain methods. The mass and dimensions of the wood product are measured before they are submerged. At various times during the submersion event the mass and dimensions are measured. Mass gain indicates the amount of water that has been absorbed into the wood product and the dimension changes are a result of the absorbed moisture.

Although this disclosure explicitly describes applications of coatings to wood products, a person of ordinary skill in the art will appreciate that coatings made according to embodiments of the disclosure may be applied to different types of materials. As a non-limiting example, coatings of the provided compositions may be applied to other types of construction materials, including but not limited to porous materials, wood/plastic composites, gypsum, and concrete. Furthermore, coatings according to embodiments of the disclosure may be applied to surfaces other than constructions materials in any situation where the properties of the composition may be beneficial.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### EXAMPLES

The following formulations characterized in Table 1 are used in the EXAMPLES.

TABLE 1
Formulations used in the EXAMPLES

| | | Percentage of | Percent of |
|---|---|---|---|
| | | multifunctional | multifunctional |
| | | aromatic | aromatic isocyanates |
| | | isocyanates | under 300 daltons in |
| | Type of | in the total | isocyanate component |
| Formulation | isocyanates | formulation | of the formulation |
| W-15 | Isomers and | 100% | Approximately 93% |
| | oligomers of MDI | | |
| ISO-5 | Isomers and | 44% | Approximately 48% |
| | oligomers of MDI | | |
| Apinee 80-R | NA | 0% | 0% |
| SIS-2 | Isomers and | 50% | Approximately 93% |
| | oligomers of MDI | | |
| pMDI | Isomers and | 100% | Approximately 48% |
| | oligomers of MDI | | |

### Example 1

### First Parallel Strand Lumber Three-Day One-Sided Wetting Test

A comparative coating known as ISO-5 containing approximately 40% isocyanate, by mass, with 48% of the isocyanate component being multifunctional isocyanates with a molecular weight under 300 daltons (in the form of mixed isomers of MDI), and the remaining 52% being higher molecular weight oligomers of MDI, was applied to two opposing major faces (2.0″×2.0″) of blocks (2.0″×2.0″×1.5″) of parallel strand lumber (Parallam brand produced by Weyerhaeuser) at a spread rate of about 15 g/ft² using an air-pressurized paint gun.

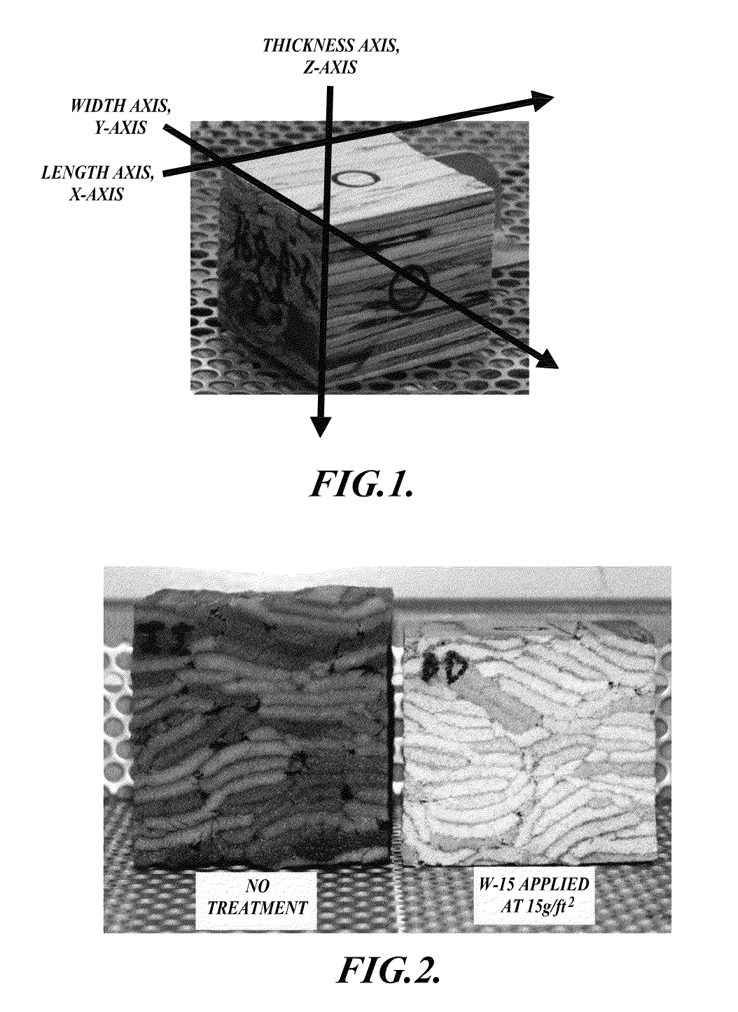

FIG. 1 is a photograph of a block of parallel strand lumber (as used in several of the EXAMPLES) and labeled reference axes.

A representative coating known as W-15 containing approximately 93%, by mass, multifunctional aromatic isocyanates with a molecular weight below 300 daltons, and the remaining 7% being higher molecular weight oligomers of MDI, was also applied to two opposing major faces (2.0″×2.0″) of blocks (2.0″×2.0″×1.75″) of parallel strand lumber at a spread rate of approximately 15 g/ft².

The moisture absorption of representative and comparative coated blocks were compared to uncoated blocks of parallel strand lumber in a three-day one-sided wetting test (with wetting occurring on one of the 2″×2″ major surfaces of each block). The average amount of moisture absorbed by the blocks is provided in Table 2.

TABLE 2
Moisture absorption test data

| | | | | Percentage of | Percent of |
|---|---|---|---|---|---|
| | Average | Average | | multifunctional | multifunctional aromatic |
| | mass of | mass of | Average mass | aromatic | isocyanates under 300 |
| | water | water | of water | isocyanates in | daltons in isocyanate |
| | absorbed | absorbed | absorbed | the total | component of the |
| Formulation | after 1 Day | after 2 days | after 3 days | formulation | formulation |
| None | 44.6 g | 47.8 g | 53.2 g | NA | NA |
| ISO-5 | 6.5 g | 17.9 g | 32.5 g | 44% | 48% |
| W-15 | 3.0 g | 9.3 g | 13.5 g | 100% | 93% |

FIG. 2 is a photograph of cross-sectional cuts of an untreated parallel strand lumber sample and one treated with a representative composition (W-15) at the end of a three day one-sided wetting test. The major face pictured for each sample is not the face directly exposed to water, but is instead a face on the side of the block. This view illustrates the impact of water absorption on the inner region of the wood product.

### Example 2

### Solid Sawn Lumber Fourteen-Day Submersion Test

Ten sections of southern yellow pine lumber were treated with different penetrating liquid formulations and then subjected to a post curing step. The specimens were approximately 1.5″ thick×3.5″ wide×6.25″ long. The specimens were cut to minimize any defects and were sorted into similar density groups.

Ten sections of southern yellow pine were treated with a phenol formaldehyde resin (i.e., no isocyanates present) formulation known as Apinee 80R using a double vacuum treatment cycle in a pressure treating vessel. The treated specimens were then cured for 24 hours at 55° C.

Ten more sections were dip treated for 20 seconds with a penetrating liquid formulation that consisted of 50% vinyltrimethoxy silane and 50%, by mass, aromatic isocyanates. The isocyanate component consisted of approximately 93% multifunctional aromatic isocyanates (MDI) with a molecular weight below 300 daltons, and the remaining 7% being higher molecular weight oligomers of MDI. This formulation is known as SIS-2. The dip treated specimens were then stored in a 90% humidity room for seven days to facilitate curing. All of the specimens were then subjected to a 14-day submersion test. The average amount of formulation that was absorbed into the specimens and the average amount of water absorbed after 7 days and 14 days of submersion are provided in Table 3.

TABLE 3
Moisture absorption test data

| | | | | | Percent of |
|---|---|---|---|---|---|
| | | | | | multifunctional |
| | | | Average | | aromatic |
| | Average | Average | mass of | Percentage of | isocyanates under |
| | mass of | mass of | water | multifunctional | 300 daltons in |
| | formulation | water | absorbed | aromatic isocyanates | isocyanate |
| | absorbed into | absorbed | after 14 | in the total | component of the |
| Formulation | specimens | after 7 days | days | formulation | formulation |
| None | NA | 141 g | 177g | NA | NA |
| Apinee 80-R | 36g | 78 g | 123 g | 0% | 0% |
| SIS-2 | 3 g | 30 g | 54 g | 50% | 93% |

### Example 3

### Second Parallel Strand Lumber Three-Day One-Sided Wetting Test

Six blocks (2.0″×2.0″×1.75″) of parallel strand lumber were coated on two opposing major faces (2.0″×2.0″) with W-15, containing approximately 93%, by mass, multifunctional aromatic isocyanates with a molecular weight below 300 daltons at a spread rate of approximately 8.0 g/ft².

Six more blocks (2.0″×2.0″×1.75″) were coated on two opposing major faces (2.0″×2.0″) with a polymeric methylene bisphenol diisocyanate (pMDI) known as Rubinate 1840 supplied by Huntsman Polyurethanes, which contains less than 50% multifunctional aromatic isocyanates with a molecular weight below 300 daltons. The same 8.0 g/ft² spread rate was used for the pMDI coated blocks. These coated blocks of parallel strand lumber were compared to uncoated blocks of parallel strand lumber in a three day one-sided wetting test. The average amount of moisture gained by the blocks is provided in Table 4 and the average thickness increase is provided in Table 5.

TABLE 4
Average mass gain due to water absorption.

| | | | | | Percent of |
|---|---|---|---|---|---|
| | | | | | multi- |
| | | | | | functional |
| | | | | Percentage | aromatic |
| | | | | of multi- | isocyanates |
| | Average | Average | Average | functional | under 300 |
| | mass of | mass of | mass of | aromatic | daltons in |
| | water | water | water | isocyanates | isocyanate |
| | absorbed | absorbed | absorbed | in | component |
| Formu- | after | after 2 | after 3 | the total | of the |
| lation | 1 day | days | days | formulation | formulation |
| None | 33.8 g | 42.8 g | 48.0 g | NA | NA |
| pMDI | 21.6 g | 31.5 g | 39.0 g | 100% | 48% |
| W-15 | 4.3 g | 6.5 g | 8.0 g | 100% | 93% |

TABLE 5
Average thickness increase due to water absorption.

| | | | | | Percent of |
|---|---|---|---|---|---|
| | | | | | multifunctional |
| | | | | Percentage | aromatic |
| | | | | of multi- | isocyanates |
| | Average | Average | Average | functional | under 300 |
| | thickness | thickness | thickness | aromatic | daltons in |
| | increase | increase | increase | isocyanates | isocyanate |
| | after | after | after 3 | in | component of |
| For- | 1 day | 2 days | days | the total | the |
| mulation | (Inches) | (Inches) | (Inches) | formulaon | formulation |
| None | 0.205″ | 0.255″ | 0.268″ | NA | NA |
| pMDI | 0.142″ | 0.201″ | 0.241″ | 100% | 48% |
| W-15 | 0.039″ | 0.062″ | 0.074″ | 100% | 93% |

FIG. 3 is a photograph of cross-sectional cuts of a side-by-side comparison between parallel strand lumber samples exposed to a three day one-sided wetting test. The major face pictured for each sample is not the face directly exposed to water, but is instead a face on the side of the block. This figure illustrates the impact of water absorption on the inner region of the wood product. The exemplary W-15 treatment remains dry and is not warped. The control and Rubinate samples are wet and warped.

FIG. 4 is a photograph of faces on the sides of blocks of parallel strand lumber samples treated with a representative formulation after exposure to a three day one-sided wetting test.

FIG. 5 is a photograph of faces on the sides of blocks of untreated parallel strand lumber samples after exposure to a three day one-sided wetting test.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of forming a water-resistant wood product, comprising:
applying a liquid formulation to a surface of a wood product, the liquid formulation comprising 5%-100%, by mass, of aromatic multifunctional isocyanates, wherein 55%-100%, by mass, of the aromatic multifunctional isocyanates have a molecular weight of 300 daltons or less; and
reacting the aromatic multifunctional isocyanates with a reactant in order to provide a water-resistant wood product; wherein the reactant is selected from the group consisting of water, a wood-based alcohol functional group, and combinations thereof.

2. The method of claim 1, wherein the liquid formulation comprises from 90% to 100%, by mass, of aromatic multifunctional isocyanates.

3. The method of claim 1, wherein 90% to 100%, by mass, of the aromatic multifunctional isocyanates have a molecular weight of 300 daltons or less.

4. The method of claim 1, wherein the aromatic multifunctional isocyanates are selected from the group consisting of diphenylmethane 4,4′ diisocyanate; diphenylmethane 2,4′ diisocyanate; and diphenylmethane 2,2′ diisocyanate, and combinations thereof.

5. The method of claim 1, wherein reacting the aromatic multifunctional isocyanates comprises deliberate exposure to water.

6. The method of claim 5, wherein deliberate exposure to water comprises a technique selected from the group consisting of exposure to a humidity room, exposure to steam, and a liquid water spray.

7. The method of claim 1, wherein applying the liquid formulation to the surface of the wood product comprises a technique selected from the group consisting of spray systems, extruders, curtain coaters, roll coaters, vacuum treating, pressure treating, hand-held brush, and combinations thereof.

8. The method of claim 1, wherein the liquid formulation is applied to every exterior surface of the wood product.

9. The method of claim 1, wherein the liquid formulation is applied to the surface of the wood product in an amount of from about 1 g/ft² to about 100 g/ft².

10. The method of claim 1, wherein the liquid formulation is applied to the surface of the wood product in an amount of from about 10 g/ft² to about 60 g/ft².

11. The method of claim 1, wherein the liquid formulation has a viscosity of 100 centipoise or less.

12. The method of claim 1, wherein the liquid formulation comprises less than 50%, by mass, of one or more additives.

13. The method of claim 12, wherein the one or more additives is selected from the group consisting of penetration aids, colorants, catalysts, preservatives, biocides, and diluents.

14. The method of claim 1, wherein the wood product is selected from the group consisting of I-joists, trusses, glulam, solid sawn lumber, parallel strand lumber (PSL), oriented strand board (OSB), oriented strand lumber (OSL), laminated veneer lumber (LVL), laminated strand lumber (LSL), particleboard, cross-laminated timber, and medium density fiberboard (MDF).

15. The method of claim 1, wherein the water-resistant wood product will absorb less water after prolonged exposure than an untreated wood product that is not treated with the liquid formulation.

16. The method of claim 1, wherein the reactant is water produced by a technique selected from the group consisting of a humidity room, steam, and a liquid water spray.

17. The method of claim 1, wherein reacted aromatic multifunctional isocyanates do not form a film on the surface of the wood product.

18. A water-resistant wood product formed by the method of claim 1.

19. The water-resistant wood product of claim 18, wherein the wood product is selected from the group consisting of I-joists, trusses, glulam, solid sawn lumber, parallel strand lumber (PSL), oriented strand board (OSB), oriented strand lumber (OSL), laminated veneer lumber (LVL), laminated strand lumber (LSL), particleboard, cross-laminated timber, and medium density fiberboard (MDF).

20. The water-resistant wood product of claim 18, wherein the aromatic multifunctional isocyanates are selected from the group consisting of diphenylmethane 4,4′ diisocyanate; diphenylmethane 2,4′ diisocyanate; and diphenylmethane 2,2′ diisocyanate, and combinations thereof.
